(19) United States
(12) Patent Application Publication
(10) Pub. No.: US 2020/0019121 A1
(43) Pub. Date: Jan. 16, 2020

(54) SMART WATCH

(71) Applicant: Dong HAN, Shenzhen (CN)

(72) Inventor: Dong HAN, Shenzhen (CN)

(21) Appl. No.: 16/155,086

(22) Filed: Oct. 9, 2018

(30) Foreign Application Priority Data
Jul. 13, 2018 (CN) 201821110501.5

(51) Int. Cl. G04B 37/14; G04G 17/08; A44C 5/14

(52) U.S. Cl. CPC G04B 37/1486; A44C 5/14; G04G 17/08

(57) ABSTRACT

A smart watch, wherein comprises a frame, a main unit disposed in the frame, and a strap detachably connecting to the frame, an end of the frame is extending and has a connection portion arranged, applied to connecting the strap and the frame, the main unit has a fixing block arranged, applied to fixing the strap, and the connection portion has an accommodation groove arranged, applied to accommodating the fixing block. The present invention achieves a goal of an easy disassembly by using the mutual displacement constraint between different components of the smart watch, while making the smart watch not produce a plurality of problems including disassembling a product or missing and losing a part, no matter the smart watch is worn or not worn, and the data connector is further hidden in the frame, thus not affecting an overall appearance and wearing of the product.

### CROSS-REFERENCES TO RELATED APPLICATIONS

This application claims the priority of Chinese Patent Application No. 201821110501.5, filed on Jul. 13, 2018, the entire contents of all of which are incorporated herein by reference.

### FIELD OF THE INVENTION

The present invention relates to the field of wearable smart device technology, and more particularly, to a smart watch.

### BACKGROUND

Following a development of wireless technology, a wearable smart device has generally been favored more and more. At present, a technology of a smart watch is the most mature, which is not only able to show time, but has a plurality of other functions, including a navigation, a calibration, a reminding and more, as well as interconnecting with a smart phone, and supporting some functions of a cell phone, including reminding a Wechat message, making a call, replying a text message, receiving and viewing a mail, and more. An application of the smart watch has been seen more and more widespread. Thus, the smart watch has been more and more popular in recent years.

A basic structure of the smart watch comprises a main unit and a strap, since the main unit of the smart watch has concentrated a plurality of functional modules, including a driving circuit, a central processing unit, a battery, an antenna and more, the smart watch is unable to carry a battery of a large capacity, thereby affecting an endurance of the smart watch. Therefore, in a daily using of a smart watch, recharging the battery frequently is unavoidable. Meanwhile, maintaining a smart watch and replacing an accessory is also unavoidable.

All above, providing a smart watch having a low cost and easy to maintain or replace accessories becomes necessary. How to make a use of a mutual displacement constraint when assembling a smart watch, so as to make a product more solid and more reliable after assembled, and easier to disassemble when replacing the strap and recharging the battery, has become an urgent problem to solve in the field.

Therefore, the current technology needs to be improved and developed.

### BRIEF SUMMARY OF THE DISCLOSURE

According to the above described defects, the purpose of the present invention is providing a smart watch, in order to achieve an easy disassembly and assembly of a product through the mutual displacement constraint when assembling the smart watch.

In order to achieve the above mentioned goals, the technical solution of the present invention to solve the technical problems is as follows:

A smart watch, wherein comprises a frame, a main unit disposed in the frame, and a strap detachably connecting to the frame, an end of the frame extends and arranges a connection portion, applied to connecting the strap and the frame, the main unit has a fixing block arranged, applied to fixing the strap, and the connection portion has an accommodation groove arranged, applied to accommodating the fixing block.

Further, the strap has a mounting end in a wedge shape arranged, applied to connecting the strap and the connection portion, the connection portion has a sliding slot arranged outside, applied to connecting slidably and adapting to the mounting end.

Further, the mounting end has a fixing slot arranged, applied to engaging the fixing block and fixing the strap to the connection end.

Further, the main unit comprises a lower case and an upper cover, in a cavity of the lower case, there are a plurality of electronic components and a battery arranged.

Further, the fixing block comprises a data connector connecting electronically to the electronic components.

Further, the fixing block is arranged on a sidewall of a lower end of the lower case.

Further, the main unit connects detachably to a lower end of the frame.

Further, an outer sidewall of the main unit has an engagement block arranged protruding to an outside of the main unit, an inner sidewall of the frame has an engaging slot arranged, applied to accommodating the engagement block, and a protruding block arranged in the engaging slot and protruding to an inside of the frame, the engagement block is engaged with the protruding block and fixing the main unit to the frame.

Further, the engagement block and the protruding block are both arranged in an arc shape.

Further, a sidewall of the frame has a plurality of heat dissipation holes arranged, applied to proving the main unit a heat dissipation space.

All above, the present utility body has a plurality of beneficial effects listed below: achieving a goal of an easy disassembly and assembly by using the mutual displacement constraint between different components of the smart watch during assembling, while making the smart watch not produce a plurality of problems including disassembly the product or missing and losing a part, no matter the smart watch is worn or not worn, and the data connector is further hidden in the frame, thus not affecting an overall appearance and wearing of the product.

### BRIEF DESCRIPTION OF THE DRAWINGS

FIG. 1 illustrates a schematic diagram of a front view of the smart watch in the present embodiment;

FIG. 2 illustrates an explored diagram of the smart watch in the present embodiment;

FIG. 3 illustrates an explored diagram in another view angle of the smart watch in the present embodiment;

FIG. 4 illustrates a schematic diagram of a back view of the smart watch in the present embodiment;

Wherein: 1. Frame; 11. Engaging slot; 12. Protruding block; 13. Heat dissipating hole; 2. Main unit; 21. Upper cover; 22. Lower case; 23. Data connector; 24. Fixing block; 25. Engagement block; 3. Strap; 31. Mounting end; 32. Fixing slot; 4. Connection portion; 41. Sliding slot; 42. Accommodation groove.

### DETAILED DESCRIPTION OF EMBODIMENTS

In order to make the purpose, technical solution and the advantages of the present invention clearer and more explicit, further detailed descriptions of the present invention are stated hereafter, referencing to the attached drawings and some preferred embodiments of the present invention. It should be understood that the detailed embodiments of the invention described here are used to explain the present invention only, instead of limiting the present invention.

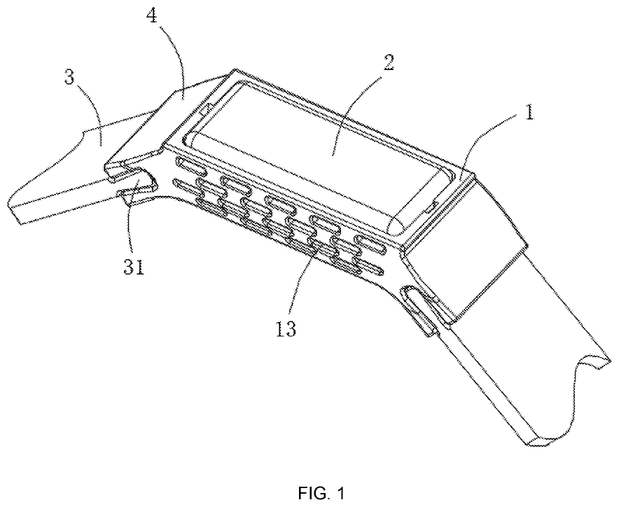

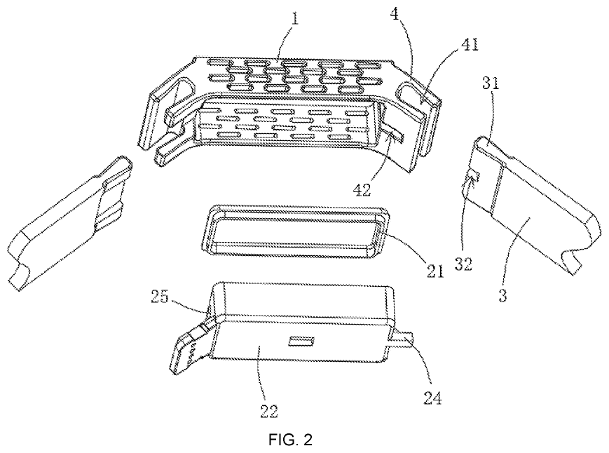

Embodiment: a smart watch, shown as FIG. 1 and FIG. 2, comprises a frame 1, a main unit 2 disposed in the frame 1, and a strap 3 detachably connecting to the frame 1, an end of the frame 1 is extending and has a connection portion 4 arranged, applied to connecting the strap 3 and the frame 1, the main unit 2 has a fixing block 24 arranged, applied to fixing the strap 3, and the connection portion 4 has an accommodation groove 42 arranged, applied to accommodating the fixing block 24. Each of both sidewalls of the frame 1 has a plurality of heat dissipation holes 13 arranged, applied to proving the main unit 2 a heat dissipation space.

Specifically, two straps 3 are arranged symmetrically on both ends of the frame 1, while each of the both ends of the frame 1 has a connection portion 4 arranged, applied to connecting the strap 3 accordingly, the fixing block 24 is arranged in the connection portion 4 accordingly, by extending a sidewall of the main unit 2.

Thus, both the main unit 2 and the strap 3 are arranged in the frame 1, forming a whole body. Since the smart watch needs to be disassembled when necessary, and needs to be secure after assembling, thus, through a mutual displacement constraint of the smart watch during assembling a plurality of different parts of the smart watch, making a plurality of accessory components of the smart watch disassemble easily, and avoiding a disassembly of the accessory components and a loss of the parts, which is specifically described as below.

The strap 3 has a mounting end 31 in a wedge shape arranged, applied to mounting the strap 3 and the connection portion 4, the connection portion 4 has a sliding slot 41 arranged outside, applied to connecting slidably and adapting to the mounting end 31. The mounting end 31 has a fixing slot 32 arranged, applied to engaging the fixing block 24 and fixing the strap 3 to the connection end.

Specifically, each end of the main unit 2 has a fixing block 24 arranged, and engaged into a fixing slot 32 in the strap 3 accordingly, making a sliding direction of each of the mounting ends 31 in the sliding slot 41 respectively get restricted, thus finished fixing the strap 3 through the frame 1 and the main unit 2, ensuring a stable installation of the strap 3 and the frame 1.

That is, the strap 3 slides before being mounted to the frame 1 through the sliding slot 41, the mounting end 31 is a structure designed with a large head and a small neck, the sliding slot 41 is a structure designed with a large inner diameter and a small opening. During mounting, each of the mounting ends 31 slides into before being mounted to the sliding slot 41 accordingly, through such a tenon-joint structure described above, it makes each of the mounting ends 31 not be able to fall off from the sliding slot 41 accordingly. When each of the mounting ends 31 slides into the sliding slot 41 accordingly, since other directions are limited by the frame 1, and not able to move, thus, each of the mounting ends 31 may only slide following a direction of the sliding slot 41.

Further, the mounting end 31 and the sliding slot 41 are engaged in an interference fit, generating a frictional force through the engagement in the interference fit, that makes each of the mounting ends 31 not easy to slide in the sliding slot 41 accordingly.

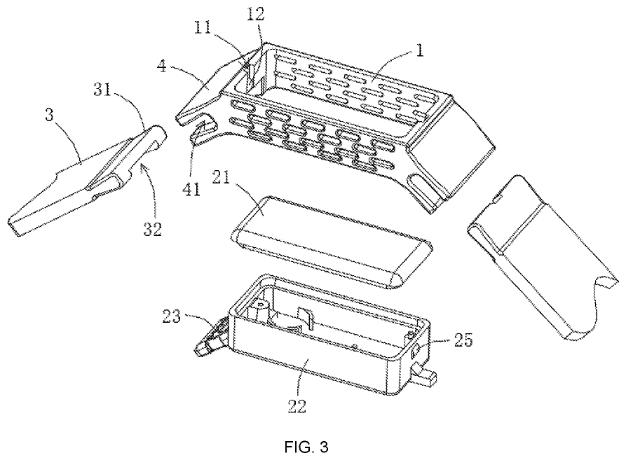

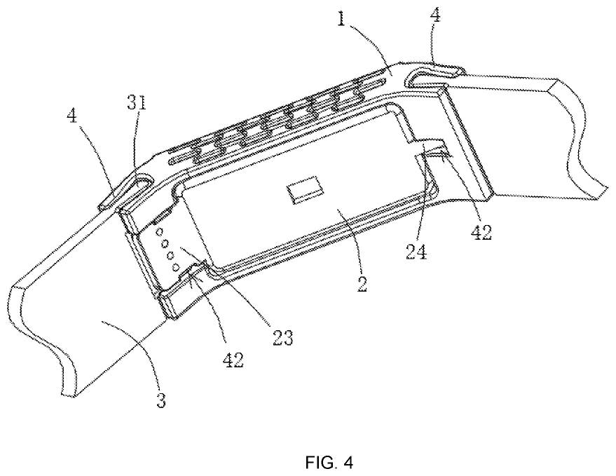

Shown as FIG. 3 and FIG. 4, the main unit 2 connects detachably to a lower end of the frame 1. An outer sidewall of the main unit 2 has an engagement block 25 arranged, protruding to an outside of the main unit 2, an inner sidewall of the frame 1 has an engaging slot 11 arranged, applied to accommodating the engagement block 25, and a protruding block 12 arranged in the engaging slot 11 and protruding to an inside of the frame 1, the engagement block 25 is engaged with the protruding block 12 and fixing the main unit 2 to the frame 1. Both the engagement blocks 25 and the protruding block 12 are arranged in an arc shape.

Specifically, the main unit 2 is mounted from a lower end of the frame 1, and fixed to the frame 1 through the engagement in the interference fit between the engagement block 25 and the protruding block 12.

Since both the engagement block 25 and the protruding block 12 are designed as an arc, when they meet, an interference fit will be generated. Continue increasing an external force and making both of them continue moving while overcoming the interference fit, until a displacement of the main unit 2 is restricted by a structure of the frame 1 and unable to move any more, before finishing an assembly. When the main unit 2 has been installed in place, if the main unit 2 needs to move down according to the frame 1, then overcoming the interference fit between both protrusions will be needed, and, if there is no external force applied onto the main unit 1, the main unit 1 will be unable to overcome the interference fit and generate a large displacement between each other, before falling off the frame 1, and if the external force is large, the main unit 2 will be able to fall off the frame 1, that makes remove the main unit 2 possible. When the watch is worn on an arm, even subjected to a large external force, the main unit 2 will not fall off the frame 1, due to a constrain provided by the arm, the main unit 2 will not fall off the frame 1, thus a case of losing a main unit 2 in a state of wearing will not be generated.

Herein, a plurality of structures of the interference fit are designed as a protrusion in an arc shape, while other structure designation methods capable of generating the interference fit between two components may also achieve such a design effect, only a preferred mode is provided here.

The main unit 2 comprises an upper cover 21 and a lower case 22, in a cavity of the lower case 22, there is a plurality of electric boards, electronic components and a battery arranged. The fixing block 24 is a data connector 23 connecting electrically to a plurality of electronic components. The fixing block 24 is arranged on a sidewall of an lower end of the lower case 22.

Preferably, in another embodiment of the present invention, wherein one of the fixing blocks 24 may be further designed as a data connector 23 connecting electrically to a plurality of electronic components, when one of the fixing blocks 24 is designed as the data connector 23, a fixing slot 32 according to the data connector 23 is designed into a size matching the data connector 23, forming a structure as shown in FIG. 4.

The data connector 23 and the fixing block 24 arranged on both sides of the main unit 2 provide the strap 3 the displacement constraint of following the sliding direction of the sliding slot 41 on one hand, and provide a displacement constraint to the main unit 2 according to a direction of an opening of the frame 1. Designing one extension end into the data connector 23, and the data connector 23 is preferred to be a USB data connector, thus the main unit 2 inserts directly to a USB dock through the data connector 23, including a computer or a power bank, in such a way, the smart watch needs no extra structures providing recharges and data connections. Meanwhile, the data connector 23 will be hiding inside the frame 1 after the smart watch is finished assembling, and not affecting an overall appearance and wearing of the product, thus providing a convenience to a user.

All above, the present utility body achieves a goal of an easy disassembly and assembly by using the mutual displacement constraint between different components of the smart watch during assembling, while making the smart watch not produce a plurality of problems including disassembling the product or missing and losing a part, no matter the smart watch is worn or not worn, and the data connector is further hidden in the frame, thus not affecting an overall appearance and wearing of the product.

The above descriptions are only the preferred embodiments of the present invention, and the configuration is not limited to the above-listed shapes, and any modifications, equivalent substitutions and improvements made within the spirit and principles of the present invention should belong to the scope of protection of the present invention.

What is claimed is:

1. A smart watch, wherein comprises a frame, a main unit disposed in the frame, and a strap detachably connecting to the frame, an end of the frame extends and arranges a connection portion, applied to connecting the strap and the frame, the main unit has a fixing block arranged, applied to fixing the strap, and the connection portion has an accommodation groove arranged, applied to accommodating the fixing block.

2. The smart watch according to claim 1, wherein the strap has a mounting end in a wedge shape arranged, applied to connecting the strap and the connection portion, the connection portion has a sliding slot arranged outside, applied to connecting slidably and adapting to the mounting end.

3. The smart watch according to claim 2, wherein the mounting end has a fixing slot arranged, applied to engaging the fixing block and fixing the strap to the connection end.

4. The smart watch according to claim 3, wherein the main unit comprises a lower case and an upper cover, in a cavity of the lower case, there is a plurality of electronic components and a battery arranged.

5. The smart watch according to claim 4, wherein the fixing block comprises a data connector connecting electronically to the electronic components.

6. The smart watch according to claim 4, wherein the fixing block is arranged on a sidewall of a lower end of the lower case.

7. The smart watch according to claim 1, wherein the main unit connects detachably to a lower end of the frame.

8. The smart watch according to claim 7, wherein an outer sidewall of the main unit has an engagement block arranged protruding to an outside of the main unit, an inner sidewall of the frame has an engaging slot arranged, applied to accommodating the engagement block, and a protruding block arranged in the engaging slot and protruding to an inside of the frame, the engagement block is engaged with the protruding block and fixing the main unit to the frame.

9. The smart watch according to claim 8, wherein the engagement block and the protruding block are both arranged in an arc shape.

10. The smart watch according to claim 1, wherein each of both sidewalls of the frame has a plurality of heat dissipation holes arranged, applied to proving the main unit a heat dissipation space.
